(19) United States
(12) Patent Application Publication
(10) Pub. No.: US 2016/0059926 A1
(43) Pub. Date: Mar. 3, 2016

(54) HYDRAULIC OPERATING DEVICE FOR A BICYCLE

(71) Applicant: Shimano Inc., Osaka (JP)

(72) Inventors: Osamu Kariyama, Sakai-shi (JP); Masahiro Nakakura, Sakai-shi (JP)

(21) Appl. No.: 14/473,891

(22) Filed: Aug. 29, 2014

(51) Int. Cl. B62L 3/02

(52) U.S. Cl. CPC B62L 3/023

(57) ABSTRACT

A hydraulic operating device according to the present invention at least comprises a master cylinder, a reservoir fluidly connected to the master cylinder and having an opening, and a first cover configured to cover the opening of the reservoir so as to contact with a fluid, the first cover being sufficiently rigid so as to keep shape of the first cover when the master cylinder is actuated to flow the fluid into and out of the master cylinder.

### FIELD OF THE INVENTION

The present invention relates to a hydraulic operating device that provides a rigid cover in a reservoir to increase braking responsiveness and sensitivity.

### BACKGROUND OF THE INVENTION

Brakes for bicycles or other vehicles typically include hydraulic brakes and mechanical brakes. Hydraulic brakes can provide greater force to friction members than mechanical brakes when an identical input force is applied to brake-levers in the brakes. Further, hydraulic brakes are easier than mechanical brakes as for cable or hose arrangement.

However, the pressure of the fluid in the hydraulic brakes may vary based on the temperature of the surrounding environment. This fluctuation in pressure may necessitate an increase in tolerances in the brakes to decrease the likelihood of brake rubbing. Therefore, compliant reservoirs have been introduced into hydraulic brake design to attenuate the pressure fluctuations. However, the compliant reservoirs may affect the sensitivity and responsiveness of the brakes.

### SUMMARY OF THE INVENTION

In view of the above, there exists a need for a hydraulic operating device which enables the device to provide high sensitivity and responsiveness during certain operating conditions and provide increased compliance of fluid pressure fluctuations during other operating conditions.

The present invention has been developed to address the aforementioned need and has an object to provide a hydraulic operating device which is modular and enables a user to vary the characteristics of the device to provide increase sensitivity and responsiveness during certain operating conditions and provide increased compliance to pressure fluctuations during other operating conditions.

According to a first aspect of the invention, there is provided a hydraulic operating device, comprising a master cylinder, a reservoir fluidly connected to the master cylinder and having an opening, and a first cover configured to cover the opening of the reservoir so as to contact with a fluid, the first cover being sufficiently rigid so as to keep shape of the first cover when the master cylinder is actuated to flow the fluid into and out of the master cylinder. One potential advantage of this type of configuration is that the fluid flows immediately from the master cylinder in response to movement of a piston provided in the master cylinder, thereby improving braking sensitivity and responsiveness. Thus, a good braking control can be maintained.

In the first aspect, the first cover may have a first protrusion on a side facing the fluid of the reservoir. One potential advantage of providing the first protrusion in the first cover is to increase the structural integrity of the first cover.

In the first aspect, the first cover may be flat on a side facing the fluid of the reservoir. One potential advantage of providing the flat surface in the first cover is a decreased manufacturing cost of the first cover.

In the first aspect, the hydraulic operating device may further include a second cover configured to replace the first cover so as to cover the opening of the reservoir, the second cover being elastically deformable so as to change shape of the second cover when the master cylinder is actuated to flow the fluid into and out of the master cylinder is provided. One potential advantage of providing the second cover in the device is to increase the modularity of the device, thereby enabling a user to choose the type of cover which suits their desired device operating characteristics.

In the first aspect, the first cover and the second cover may be disposed in a common location with respect to the reservoir. One potential advantage of this configuration is that the first and second covers can be easily interchanged in the device.

In the first aspect, the respective outer perimeter profiles of each of the first cover and the second cover may be the same shape. One potential advantage of this type of configuration is further simplifying interchanging of the first and second covers in the device.

In the first aspect, the first cover may have a first protrusion on a side facing the fluid of the reservoir, the second cover has a second protrusion on a side facing the fluid the reservoir, the second protrusion being formed in a same shape as the first protrusion. One potential advantage of this type of configuration is to enable similar manufacturing techniques to be used to create the first and second covers to decrease manufacturing costs of the first and second covers.

In the first aspect, the first cover may be made of an elastically deformable material, the first protrusion has thickness so as to keep shape of the first protrusion when the master cylinder is actuated to flow the fluid into and out of the master cylinder. One potential advantage of this type of configuration is that the first cover can be made of same material as the second cover to decrease manufacturing costs of the first and second covers

In the first aspect, the first cover may be made of a rigid material. One potential advantage of this type of configuration is to further improve braking sensitivity and responsiveness.

In the first aspect, the master cylinder and the reservoir may be configured as a single unitary member which is mounted to a bicycle handlebar. One potential advantage of this configuration is to enable the device to be easily attached to the bicycle.

In the first aspect, the reservoir may be positioned above the master cylinder in a state where the hydraulic operating device is mounted to the handlebar. One potential advantage of this configuration is a decreased likelihood of air flowing from the reservoir into the master cylinder.

In a second aspect of the invention a hydraulic operating device component system is provided. The system comprises a hydraulic operating device comprising a master cylinder, and a reservoir fluidly connected to the master cylinder and having an opening and an interchangeable pair of first and second covers configured to alternatively cover the opening of the reservoir so as to contact with a fluid respectively, the first cover being sufficiently rigid so as to keep shape of the first cover when the master cylinder is actuated to flow the fluid into and out of the master cylinder, the second cover being elastically deformable so as to change shape of the second cover when the master cylinder is actuated to flow the fluid into and out of the master cylinder. One potential advantage of this configuration is an increase in the modularity of the system which enables a user to choose the characteristics of the system which best suits their needs.

In the second aspect, the first cover and the second cover may be disposed in a common location with respect to the reservoir. One potential advantage of this configuration is enabling the covers to be easily interchanged.

In the second aspect, respective outer perimeter profiles of each of the first cover and the second cover may be the same shape. One potential advantage of this type of configuration is further simplifying interchanging of the first and second covers in the device.

In the second aspect, the first cover may have a first protrusion on a side facing the fluid of the reservoir, the second cover has a second protrusion on a side facing the fluid the reservoir, the second protrusion being formed in a same shape as the first protrusion. One potential advantage of this type of configuration is enabling similar manufacturing techniques to be used to create the first and second covers to decrease manufacturing costs of the first and second covers.

In the second aspect, the first cover may be made of an elastically deformable material, the first protrusion has thickness so as to keep shape of the first protrusion when the master cylinder is actuated to flow the fluid into and out of the master cylinder. One potential advantage of this type of configuration is that the first cover can be made of same material as the second cover to decrease manufacturing costs of the first and second covers.

In the second aspect, the first cover may be made of a rigid material. One potential advantage of this type of configuration is to further improve braking sensitivity and responsiveness.

In the second aspect, the first cover may be flat on a side facing the fluid of the reservoir, and the second cover may have a second protrusion on a side facing the fluid the reservoir. One potential advantage of this configuration is to vary the volume of the reservoir to enable the characteristics of the device to be altered when the covers are interchanged in the device.

In the second aspect, the master cylinder and the reservoir may be configured as a single unitary member which is mounted to a bicycle handlebar. One potential advantage of this configuration is that the device may be easily attached to a bicycle.

In the second aspect, the reservoir may be positioned above the master cylinder in a state where the hydraulic operating device is mounted to the handlebar. One potential advantage of this configuration is a decreased likelihood of air flowing from the reservoir into the master cylinder.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is an illustration of an example hydraulic operating device;

FIG. 2 is a schematic depiction of an example hydraulic operating device and hydraulic operating device component system;

FIG. 3 is a cross-sectional view of the hydraulic operating device shown in FIG. 1;

FIGS. 4 and 5 are different perspective views showing a first cover that may be included in the hydraulic operating device shown in FIG. 3;

FIGS. 6 and 7 are different perspective views showing a second cover that may be included in the hydraulic operating device shown in FIG. 3; and

FIGS. 8 and 9 are different perspective views showing a first cover that may be included in the hydraulic operating device shown in FIG. 3.

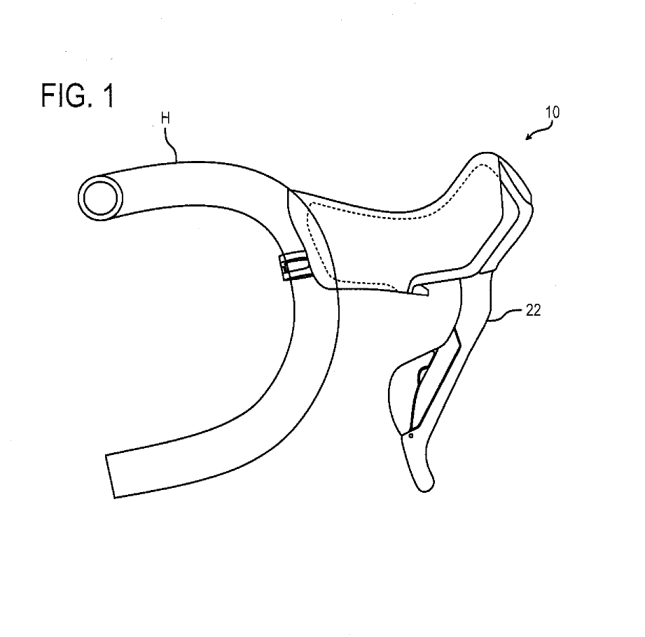

FIGS. 1, 3-9 are drawn approximately to scale, however other relative dimensions may be used in other embodiments.

### DETAILED DESCRIPTION OF THE INVENTION

Embodiments of the present invention will now be explained with reference to the drawings. The following descriptions of the embodiments of the present invention are provided for illustration only and not for the purpose of limiting the invention as defined by the appended claims and their equivalents.

Referring initially to FIG. 1, a hydraulic operating device 10 is illustrated. As shown in FIG. 1, the hydraulic operating device 10 is coupled to a bicycle handlebar H. The handlebar H depicted in FIG. 1 is a drop style handlebar and the hydraulic operating device 10 is for a road bicycle. However, it will be appreciated that the hydraulic operating device 10 may be coupled to other types of handlebars. The hydraulic operating device 10 is coupled to a braking device (not shown), e.g., a hydraulic disc brake caliper and a hydraulic rim brake caliper to reduce the speed of a bicycle wheel.

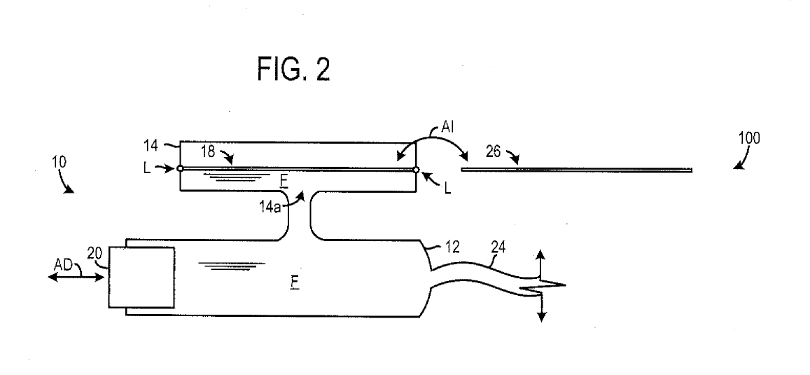

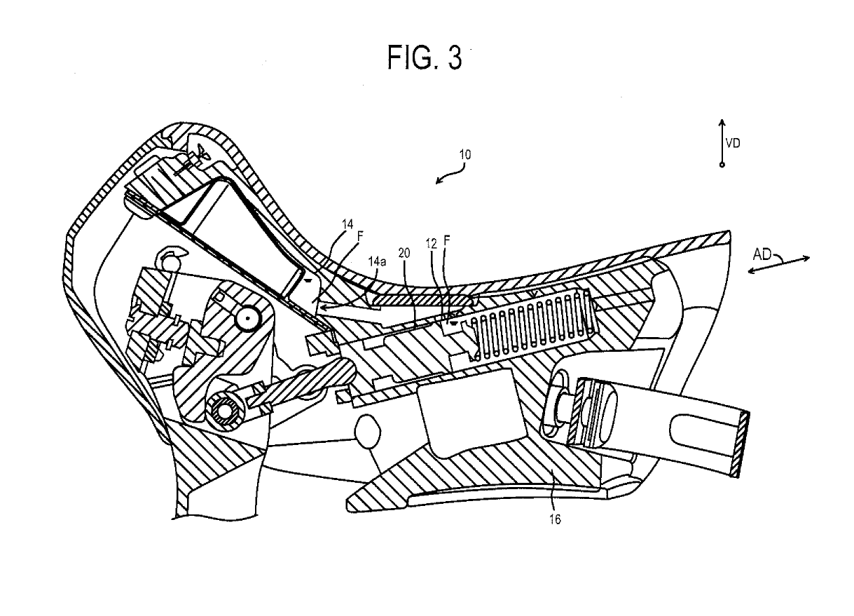

FIG. 2 schematically shows a hydraulic operating device component system 100 of the present invention. As shown in FIG. 3, the hydraulic operating device 10 of the hydraulic operating device component system 100, shown in FIG. 2, includes a master cylinder 12 and a reservoir 14 fluidly connected to the master cylinder 12 and having an opening 14a. The master cylinder 12, reservoir 14, and opening 14a, are also shown in FIG. 2. Fluid F is provided in the master cylinder 12 and reservoir 14 shown in FIGS. 2 and 3. The fluid F may be a suitable hydraulic fluid, such as DOT 4, mineral oil, etc. In the embodiment shown in FIG. 3, the master cylinder 12 and the reservoir 14 are provided on a base member 16 which is configured to be mounted on the handlebar H, shown in FIG. 1. In other words, the master cylinder 12 and the reservoir 14 are configured as a single unitary member which is mounted to the handlebar H of the bicycle. The reservoir 14 may be positioned above the master cylinder 12 in a state where the hydraulic operating device 10 is mounted to the handlebar H. A vertical direction VD is provided for reference in FIG. 3. However, in other embodiments relative position of the master cylinder and the reservoir may be altered.

As shown in FIG. 2, the hydraulic operating device 10 further includes a first cover 18 configured to cover the opening 14a of the reservoir 14 so as to contact with the fluid F. The first cover 18 is sufficiently rigid so as to keep the shape of the first cover when the master cylinder 12 is actuated to flow the fluid F into and out of the master cylinder. In this way, the first cover 18 enables the device to provide greater braking responsiveness and sensitivity in the hydraulic system.

A piston 20 is positioned in the master cylinder 12. The piston 20 is configured to alter the volume of a chamber provided between the master cylinder 12 and the piston 20 to enable the fluid F to flow into and out of the master cylinder 12 in response to actuation from an operating member 22 (FIG. 1). Arrow AD denotes actuation direction of the piston 20 in FIGS. 2 and 3. A fluid line or hose 24 is also fluidly coupled to the master cylinder 12 to fluidly connect the hydraulic operating device 10 to the braking device (not shown).

As shown in FIG. 2, the hydraulic operating device component system 100 further includes a second cover 26 configured to replace the first cover 18 so as to cover the opening 14a of the reservoir 14. In other words, the hydraulic operating device 10 may be include the second cover 26 configured to replace the first cover 18 so as to cover the opening 14a of the reservoir 14. The interchanging of the first and second covers 18 and 26 is denoted via arrow AI in FIG. 2. It will be appreciated that a user may manually perform the aforementioned cover replacement. In this way, a user can select a cover for use in the hydraulic operating device which suits their desired operating characteristics.

The second cover 26 is configured to cover the opening 14a so as to contact with the fluid F. The second cover 26 is elastically deformable so as to change shape of the second cover 26 when the master cylinder 12 is actuated to flow the fluid F into and out of the master cylinder 12. The second cover 26 is made of an elastomeric material. The second cover 26 has a function as a diaphragm, as described later.

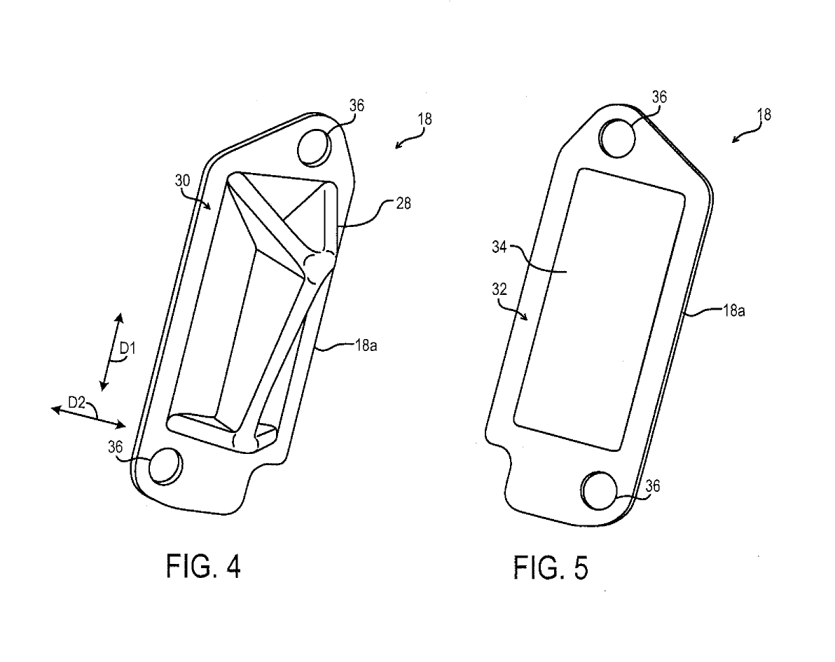

As shown in FIG. 2, the first cover 18 and the second cover 26 may be disposed in a common location L with respect to the reservoir 14. Additionally, as shown in FIGS. 4 to 7, respective outer perimeter profiles 18a and 26b of each of the first cover 18 and the second cover 26 are the same shape. In this way, the first and second covers 18 and 26 can be quickly and easily switched without any physical reconfiguration of the reservoir 14, if desired.

FIGS. 4 and 5 show different perspective views of the first cover 18. As shown in FIG. 4, the first cover 18 has a first protrusion 28 on a side 30 facing the fluid F in the reservoir 14. It will be appreciated that a side profile of the first protrusion 28 fits into and conforms to a side profile of the reservoir 14. However, in other embodiments the side 30 may have a protruding contour of a different shape. In the depicted example, the first cover 18 includes a central region made of an elastically deformable material, such as rubber or plastic, that forms the protrusion 28, and peripheral region made of a rigid material such as metal or rigid plastic and forming a perimeter around the central region. As shown in FIG. 5, on a side 32 opposite to the side 30 the protrusion 28 is filled with a rigid material such as epoxy 34, to thereby render the protrusion 28 to be substantially rigid itself. Alternatively, the first cover 18 may include the protrusion 28 made of a substantially rigid material, such as metal or a rigid plastic. In this example, the first cover 18 may have a recess similar to a recess 42 of the second cover 26 (FIG. 7 described later) on the side 32, and the protrusion 28 may have a thickness and reinforcing structure that is sufficient to impart it with a rigidity that enables it to maintain its shape even when the master cylinder 12 is actuated to flow the fluid F into and out of the master cylinder 12.

The protrusion 28 extends longitudinally as well as laterally across the first cover 18. A longitudinal direction D1 and a lateral direction D2 of the first cover 18 are provided for reference. Additionally, the height of the protrusion 28 varies in the longitudinal and lateral directions D1 and D2. Furthermore, edges of the protrusion 28 may be curved (e.g., rounded). However, numerous contours of the protrusion 28 have been contemplated.

The first cover 18 further includes attachment openings 36 enabling the first cover 18 to be attached to the base member 16. The attachment openings 36 are laterally offset. However, other attachment opening configurations may be utilized. Further in other embodiments, the first cover 18 may not include attachment openings.

As shown in FIG. 5, the side 32 of the first cover 18 is planar, in the depicted embodiment. However, alternative contours of the side 32 have been contemplated.

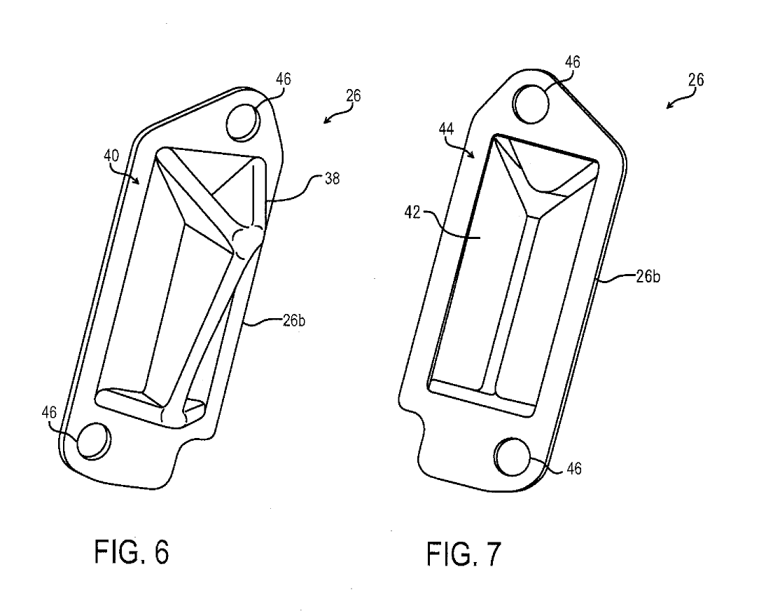

FIGS. 6 and 7 show different perspective views of the second cover 26. The second cover 26 has substantially same profile and shape as the first cover 18. It will be appreciated that the second cover 26 is configured to replace the first cover 18 so as to cover the opening 14a of the reservoir 14. As shown in FIG. 6, the second cover 26 has a protrusion 38 on a side 40 facing the fluid F in the reservoir 14. The protrusion 38 is formed in a same shape as the protrusion 28 of the first cover 18 (FIG. 4). However, the protrusions 28 and 38 can have different shapes.

As shown in FIG. 7, the second cover 26 includes a recess 42 on a side 44 opposite to the side 40. The recess 42 has a contour which corresponds to the contour of the protrusion 38. The protrusion 38 and the recess 42 have a function as a diaphragm. This diaphragm may cover at least 10% of the area of the reservoir side of the second cover 26. Alternatively, the diaphragm may be configured to cover more than 50% of the area of the cover, or 75% of the area of the cover, to provide more cross-sectional area for the diaphragm. The diaphragm may be made of an elastomeric material. The second cover 26 further includes attachment openings 46 similar to the first cover 18.

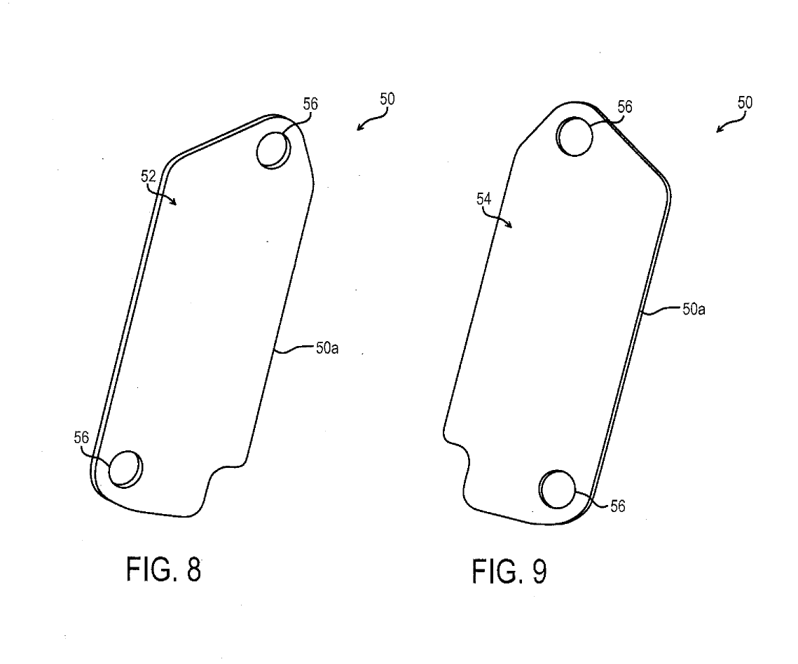

FIGS. 8 and 9 show a first cover 50, which is another embodiment. It will be appreciated that the first cover 50 may be included in the hydraulic operating device 10 shown in FIG. 3. Specifically, the first cover 50 may be interchangeable with the first cover 18 and the second cover 26 and may be configured to alternatively cover the opening 14a of the reservoir 14 so as to contact with the fluid F. Additionally, the first cover 50 may be sufficiently rigid so as to keep shape of the first cover when the master cylinder 12 is actuated to flow the fluid F into and out of the master cylinder 12.

FIG. 8 shows a side 52 may be facing the fluid F in the reservoir 14. The side 52 is planar, and thus the first cover 50 is flat on the side 52. FIG. 9 shows a side 54 opposite to the side 52. The side 54 is also planar, and thus the first cover 50 is flat on the side 54. Consequently the first cover 50 is configured as a flat plate member. However, the second side may have alternate contours. The first cover 50 also includes attachment openings 56 that enable mounting of the first cover 50 in the base member 16.

Furthermore, an outer perimeter profile 50a of the first cover 50 is the same shape as the perimeter profiles 18a and 26a of the first cover 18 (FIGS. 4 and 5) and the second cover 26 (FIGS. 6 and 7).

The above described hydraulic operating device and hydraulic operating device component system enables users to select between interchangeable first and second covers, to switch between a reservoir having a compliant diaphragm to accommodate volumetric changes in the fluid contained within the system due to temperature fluctuations, and a reservoir having a rigid cover that provides increased responsiveness of the system.

The term “comprising” and its derivatives, as used herein, are intended to be open ended terms that specify the presence of the stated features, elements, components, groups, integers, and/or steps. This concept also applies to words of similar meaning, for example, the terms “have”, “include” and their derivatives.

The terms of degree such as “substantially”, “about” and “approximately” as used herein mean a reasonable amount of deviation of the modified term such that the end result is not significantly changed (e.g., manufacturing tolerances). While specific embodiments of the hydraulic operating device and hydraulic operating device component system have been described in detail, the particular arrangements disclosed are meant to be illustrative only and not limiting. The features of the various embodiments described above, as well as modifications thereof, may be variously combined without departing from the scope of this disclosure.

What is claimed is:

1. A hydraulic operating device, comprising:
a master cylinder;
a reservoir fluidly connected to the master cylinder and having an opening; and
a first cover configured to cover the opening of the reservoir so as to contact with a fluid, the first cover being sufficiently rigid so as to keep shape of the first cover when the master cylinder is actuated to flow the fluid into and out of the master cylinder.

2. The hydraulic operating device of claim 1, wherein the first cover has a first protrusion on a side facing the fluid of the reservoir.

3. The hydraulic operating device of claim 1, wherein the first cover is flat on a side facing the fluid of the reservoir.

4. The hydraulic operating device of claim 1 further comprising:
a second cover configured to replace the first cover so as to cover the opening of the reservoir, the second cover being elastically deformable so as to change shape of the second cover when the master cylinder is actuated to flow the fluid into and out of the master cylinder.

5. The hydraulic operating device of claim 4, wherein the first cover and the second cover are disposed in a common location with respect to the reservoir.

6. The hydraulic operating device of claim 4, wherein respective outer perimeter profiles of each of the first cover and the second cover are the same shape.

7. The hydraulic operating device of claim 4, wherein the first cover has a first protrusion on a side facing the fluid of the reservoir, the second cover has a second protrusion on a side facing the fluid the reservoir, the second protrusion being formed in a same shape as the first protrusion.

8. The hydraulic operating device of claim 7, wherein the first cover is made of an elastically deformable material, the first protrusion has thickness so as to keep shape of the first protrusion when the master cylinder is actuated to flow the fluid into and out of the master cylinder.

9. The hydraulic operating device of claim 7, wherein the first cover is made of a rigid material.

10. The hydraulic operating device of claim 1, wherein the master cylinder and the reservoir are configured as a single unitary member which is mounted to a bicycle handlebar.

11. The hydraulic operating device of claim 10, wherein the reservoir is positioned above the master cylinder in a state where the hydraulic operating device is mounted to the bicycle handlebar.

12. A hydraulic operating device component system, comprising:
a hydraulic operating device comprising a master cylinder, and a reservoir fluidly connected to the master cylinder and having an opening; and
an interchangeable pair of first and second covers configured to alternatively cover the opening of the reservoir so as to contact with a fluid respectively, the first cover being sufficiently rigid so as to keep shape of the first cover when the master cylinder is actuated to flow the fluid into and out of the master cylinder, the second cover being elastically deformable so as to change shape of the second cover when the master cylinder is actuated to flow the fluid into and out of the master cylinder.

13. The hydraulic operating device component system of claim 12, wherein the first cover and the second cover are disposed in a common location with respect to the reservoir.

14. The hydraulic operating device component system of claim 12, wherein respective outer perimeter profiles of each of the first cover and the second cover are the same shape.

15. The hydraulic operating device component system of claim 12, wherein the first cover has a first protrusion on a side facing the fluid of the reservoir, the second cover has a second protrusion on a side facing the fluid the reservoir, the second protrusion being formed in a same shape as the first protrusion.

16. The hydraulic operating device component system of claim 15, wherein the first cover is made of an elastically deformable material, the first protrusion has thickness so as to keep shape of the first protrusion when the master cylinder is actuated to flow the fluid into and out of the master cylinder.

17. The hydraulic operating device component system of claim 15, wherein the first cover is made of a rigid material.

18. The hydraulic operating device component system of claim 12, wherein the first cover is flat on a side facing the fluid of the reservoir, the second cover has a second protrusion on a side facing the fluid the reservoir.

19. The hydraulic operating device component system of claim 12, wherein the master cylinder and the reservoir are configured as a single unitary member which is mounted to a bicycle handlebar.

20. The hydraulic operating device component system of claim 19, wherein the reservoir is positioned above the master cylinder in a state where the hydraulic operating device is mounted to the bicycle handlebar.
